(19) United States
(12) Patent Application Publication
(10) Pub. No.: US 2002/0184405 A1
(43) Pub. Date: Dec. 5, 2002

(54) Method, computer program product and system for providing information processing service

(76) Inventors: Mari Omori, Fuchu-shi (JP); Shigeru Matsumoto, Fuchu-shi (JP); Takashi Moriyasu, Kawasaki-shi (JP); Kimio Saba, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/098,543

(22) Filed: Mar. 18, 2002

(30) Foreign Application Priority Data
Mar. 19, 2001 (JP) 2001-079353
Mar. 13, 2002 (JP) 2002-069188

(51) Int. Cl. G06F 9/46; G06F 9/00; G06F 9/54; G06F 15/163

(52) U.S. Cl. 709/318; 709/310

(57) ABSTRACT

This invention facilitates providing an information processing service. In an information processing service providing method of the present invention by a computer, an event which requests an additional information processing service associated with an information processing service provided through a network is detected. When the event is detected, a library in which invocation of an additional function of providing the additional information processing service is defined is referred to. On the basis of the reference result of the library, the additional function of providing the additional information processing service is requested to execute processing.

### CROSS-REFERENCE TO RELATED APPLICATIONS

This application is based upon and claims the benefit of priority from the prior Japanese Patent Applications No. 2001-079353, filed Mar. 19, 2001; and No. 2002-069188, filed Mar. 13, 2002, the entire contents of which are incorporated herein by reference.

### BACKGROUND OF THE INVENTION

### FIELD OF THE INVENTION

The present invention relates to an information processing service providing method, computer program product, and information processing service providing system which support an information processing service provider.

### DESCRIPTION OF THE RELATED ART

A service provider is an agent which provides a function of, e.g., application software (to be referred to as an application hereinafter) such as business software used for businesses or its function. The service provider outputs a result obtained by the application to a request side such as a user or a system.

An example of the service provider is an ASP (Application Service Provider). For example, the ASP rents the function of a large-scale business system such as a suite business package.

The ASP also rents the application for daily use, such as document editing software or spreadsheet software.

The user can use the rental application of ASP and execute operation without installing the application in user terminal.

On the user side, the cost and labor for installing, managing, and upgrading the application can be reduced, though user has made a burden for an information system department of a company.

Generally, the user accesses the ASP using a Web browser. However, The user sometimes accesses the ASP without using any Web browser. For example, the user accesses the ASP using a browser dedicated to a portable telephone. Alternatively, the user downloads a software, that is rented by the ASP with a time limit, into the user's hard disk and uses it.

To obtain a service charge, the service provider must have a function of charging the user for the use's usage and a function of managing user information. Hence, the service provider must develop and operate a charging management function and user management function that operates in linkage with the application used by the user.

The service provider must prevent server down or information leakage between users. To do this, the service provider generally installs a server in a data center or Internet data center (to be referred to as an iDC hereinafter) which provides a facility and operation form specialized to provide a service, thereby preventing server down or information leakage.

The data center or iDC provides a physical infrastructure and operation management to the service provider.

However, some functions that are necessary for the service provider to provide a service are not realized only by using the data center or iDC.

For example, only by using the data center or iDC, functions of managing charging in accordance with the usage of an application, supporting bill creation, supporting bill sending, answering an inquiry from the user, and the like cannot be sufficiently realized.

Some service providers have no technology for developing or operating all functions necessary to provide the service by themselves. It is difficult for such service providers with insufficient technology to provide the service for executing the above functions, resulting in a obstacle in providing the service.

### BRIEF SUMMARY OF THE INVENTION

It is an object of the present invention to provide an information processing service providing method, computer product program, and information processing service providing system, which support a service provider.

According to an embodiment of the present invention, there is provided a method for providing information processing service by a computer, comprising:

detecting an event which requests an additional information processing service associated with an information processing service provided through a network;

when the event is detected, referring to a library in which invocation of an additional function of providing the additional information processing service is defined; and

on the basis of a reference result of the library, requesting the additional function of providing the additional information processing service to execute processing.

According to a still another embodiment of the present invention, there is provided a method for providing information processing service by a computer, comprising:

recording data that represents an operation state of an information processing service provided through a network; and

providing the recorded data that represents the operation state to an additional function of providing an additional information processing service associated with the information processing service.

According to a still another embodiment of the present invention, there is provided a method for providing information processing service by a computer, comprising:

acquiring a request of an information processing service provided through a network; and

in compliance with the request, requesting an additional function to execute processing, wherein the additional function provides an additional information processing service associated with the information processing service.

According to a still another embodiment of the present invention, there is provided a method for providing information processing service by a computer, comprising:

acquiring a request of an additional information processing service, which is generated on the basis of processing of an information processing service provided through a network; and

in compliance with the request, requesting an additional function to execute processing, wherein the additional function provides the additional information processing service.

According to a still another embodiment of the present invention, there is provided an article of manufacture comprising a computer usable medium having computer readable program code means embodied therein, the computer program code means comprising:

a detection computer readable program code that detects an event which requests an additional information processing service associated with an information processing service provided through a network;

a reference computer readable program code that, when the event is detected, refers to a library in which invocation of an additional function of providing the additional information processing service is defined; and

a request computer readable program code that, on the basis of a reference result of the library, requests the additional function of providing the additional information processing service to execute processing.

According to a still another embodiment of the present invention, there is provided an article of manufacture comprising a computer usable medium having computer readable program code means embodied therein, the computer program code means comprising:

a record computer readable program code that records data that represents an operation state of an information processing service provided through a network; and

a request computer readable program code that provides the recorded data that represents the operation state to an additional function of providing an additional information processing service associated with the information processing service.

According to a still another embodiment of the present invention, there is provided an article of manufacture comprising a computer usable medium having computer readable program code means embodied therein, the computer program code means comprising:

an acquisition computer readable program code that acquires a request of an information processing service provided through a network; and

a request computer readable program code that, in compliance with the request, requests an additional function to execute processing, wherein the additional function provides an additional information processing service associated with the information processing service.

According to a still another embodiment of the present invention, there is provided an article of manufacture comprising a computer usable medium having computer readable program code means embodied therein, the computer program code means comprising:

an acquisition computer readable program code that acquires a request of an additional information processing service, which is generated on the basis of processing of an information processing service provided through a network; and

a request computer readable program code that, in compliance with the request, requests an additional function to execute processing, wherein the additional function provides the additional information processing service.

According to a still another embodiment of the present invention, there is provided a system for providing information processing service, comprising:

a detection unit that detects an event which requests an additional information processing service associated with an information processing service provided through a network;

a reference unit that, when the event is detected, refers to a library in which invocation of an additional function of providing the additional information processing service is defined; and

a request unit that, on the basis of a reference result of the library, requests the additional function of providing the additional information processing service to execute processing.

According to a still another embodiment of the present invention, there is provided a system for providing information processing service, comprising:

a record unit that records data that represents an operation state of an information processing service provided through a network; and

a request unit that provides the recorded data that represents the operation state to an additional function of providing an additional information processing service associated with the information processing service.

According to a still another embodiment of the present invention, there is provided a system for providing an information processing service, comprising:

an acquisition unit that acquires a request of an information processing service provided through a network; and

a request unit that, in compliance with the request, requests an additional function to execute processing, wherein the additional function provides an additional information processing service associated with the information processing service.

According to a still another embodiment of the present invention, there is provided a system for providing an information processing service, comprising:

an acquisition unit that acquires a request of an additional information processing service, which is generated on the basis of processing of an information processing service provided through a network; and

a request unit that, in compliance with the request, requests an additional function to execute processing, wherein the additional function provides the additional information processing service.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinbefore.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing an example of a structure of an information processing service providing system according to the first embodiment of the present invention;

FIG. 2 is a block diagram showing an example of a modification of the information processing service providing system according to the same embodiment;

FIG. 3 is a block diagram showing an example of a linkage state of an information processing service providing system according to the second embodiment of the present invention;

FIG. 4 is a block diagram showing an example of a structure of the information processing service providing system according to the same embodiment;

FIG. 5 is a block diagram showing an example of a linkage state by a user-side request acquisition function;

FIG. 6 is a block diagram showing an example of a linkage state by an application-side request acquisition function;

FIG. 7 is a block diagram showing an example of an architecture of the information processing service providing system including the request acquisition functions;

FIG. 8 is a block diagram showing an example of a relationship between concrete services and the architecture of the information processing service providing system according to the same embodiment;

FIG. 9 is a class diagram showing an example of a structure of the request acquisition functions;

FIG. 10 is a class diagram showing an example of a relationship between concrete services and the structure of the request acquisition functions;

FIG. 11 is a sequence chart showing an example of the first-half operation of the user-side request acquisition function;

FIG. 12 is a sequence chart showing an example of the second-half operation of the user-side request acquisition function;

FIG. 13 is a sequence chart showing an example of the first-half operation of the application-side request acquisition function;

FIG. 14 is a sequence chart showing an example of the second-half operation of the application-side request acquisition function; and

FIG. 15 is a block diagram showing an example of a structure of an information processing service providing system according to the third embodiment of the present invention.

### DETAILED DESCRIPTION OF THE INVENTION

The embodiments of the present invention will be described below with reference to the accompanying drawing. The same reference numerals denote the same parts throughout the drawing.

A case wherein a user sends a request by operating, e.g., a Web browser will be mainly described below. However, the present invention is not limited to this. A program, computer, computer system, object, module, or process may send a request.

### FIRST EMBODIMENT

In this embodiment, an information processing service providing system for providing an additional information processing service (to be referred to as an “additional service” hereinafter) associated with an information processing service will be described.

This embodiment will be described assuming that an information technology service for ASP business is the information processing service. The ASP provides an application service to a service request side. An example of an additional service is an operation management service for an ASP.

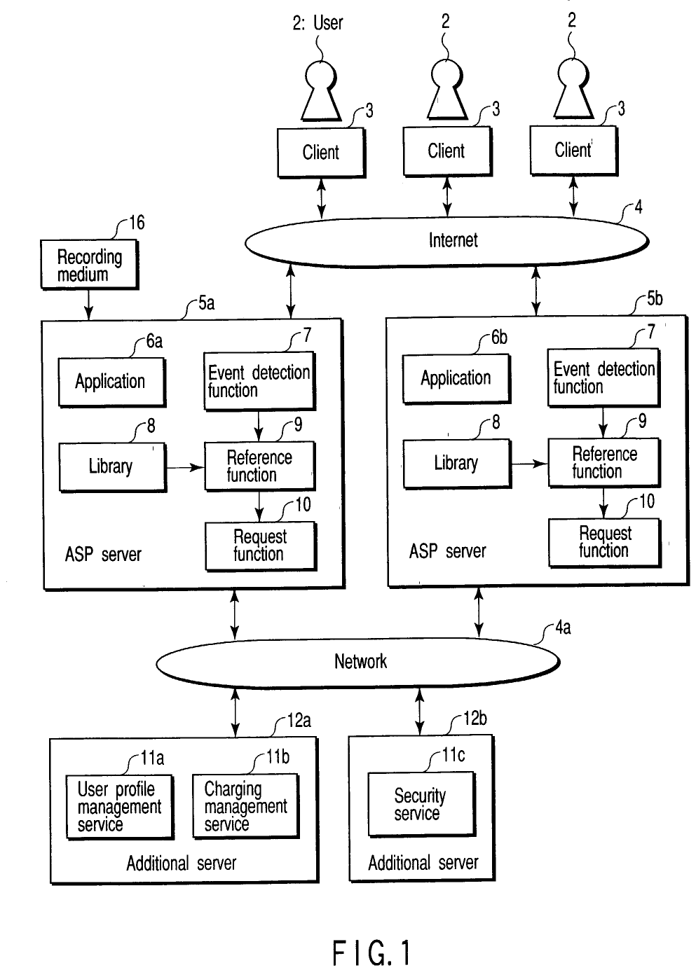

FIG. 1 is a block diagram showing an example of the information processing service providing system according to this embodiment.

A user (end user, user company, or the like) 2 of the information processing service providing system provides a request from a client 3 operated by himself to an ASP server 5a or 5b through the Internet 4. An application 6a in the ASP server 5a or an application 6b in the ASP server 5b operates on the basis of the request. Consequently, the user 2 receives an ASP service.

An event detection function 7 in each of the ASP servers 5a and 5b detects an event for requesting an additional service.

For example, when a new user accesses the ASP server 5a or 5b, the new user must be registered to manage the new user. In this case, the event detection function 7 detects an access from the new user. The event detection function 7 also detects an event for charging the user for use by the user, or an event that indicates a failure in the ASP server 5a or 5b.

A library 8 stores data or programs used to invoke functions for providing additional services 11a to 11c. The library 8 includes API (Application Program Interface) used to invoke functions for providing the additional services.

The function of providing the additional service is realized by, e.g., a program, process, module, application, computer, or computer system. To request execution of the function of providing the additional service, for example, a method of outputting a request to the function of providing the additional service, a method of providing data to the function of providing the additional service, or a method of invoking processing of the function of providing the additional service can be used.

In some cases, the library 8 is not prepared in the same hardware as that realizes a reference function 9. For this reason, the reference function 9 can refer to the library 8 through a network.

The reference function 9 refers to the library 8 when the event detection function 7 detects the event.

A request function 10 invokes a function corresponding to the type of the event detected by the event detection function 7 using the reference result of the library 8 by the reference function 9.

Each of the additional services 11a to 11c are realized when the functions of providing the additional services are requested to execute.

Referring to FIG. 1, an additional server 12a provides the user management service 11a and charging management service lb. An additional server 12b provides the security service lac.

The ASP servers 5a and 5b and additional servers 12a and 12b are connected through a network 4a.

In this embodiment, the event detection function 7, reference function 9, library 8, and request function 10 are arranged on the side of the ASP servers 5a and 5b. However, they may be arranged on the side of, e.g., the additional servers 12a and 12b. When the event detection function 7 is arranged on the side of the additional servers 12a and 12b, the event detection function 7 detects the event that takes place in the ASP server 5a or 5b through the network 4a.

In this embodiment, the ASP servers 5a and 5b, and the additional servers 12a and 12b operate on different hardware systems. However, they may operate on a single hardware system.

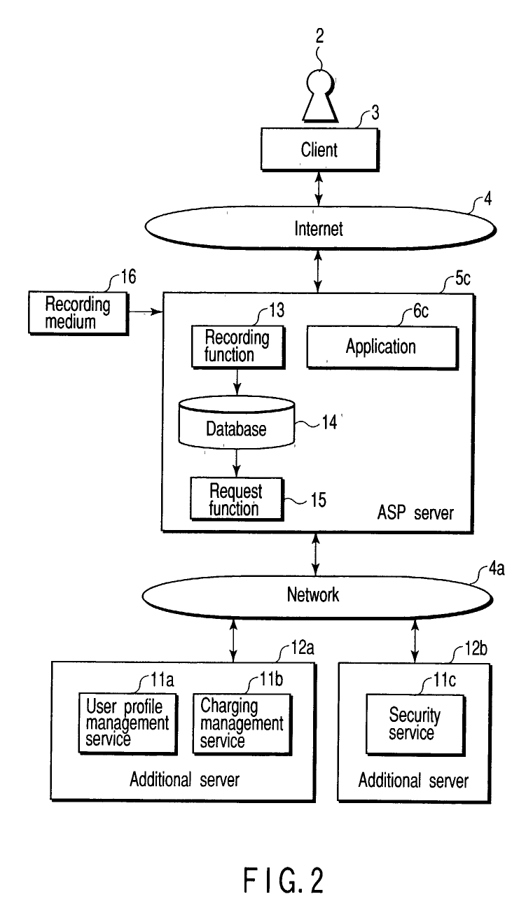

FIG. 2 is a block diagram showing an example of a modification of the information processing service providing system according to this embodiment.

A recording function 13 in an ASP server 5c records operation state data of the ASP server 5c in a database 14. The operation state data comprise, e.g., the number of times of use and the use time of an application 6c by the user 2 and the operation log information of the ASP server 5c.

A request function 15 in the ASP server 5c outputs the operation state data recorded in the database 14 to the function of providing the additional service.

Upon receiving the operation state data, the additional server 12a provides the user management service 11a or charging management service 11b. Upon receiving the operation state data, the additional server 12b provides the security service 11c.

In the above-described information processing service providing system, the applications 6a and 6b of the ASP and the functions of providing the additional services 11a to 11c operate in linkage with each other.

Hence, for example, when the iDC agent provides various kinds of additional services, this iDC agent can carry on the business with the increased added value of its data center.

When the user 2 receives a plurality of ASP services, and the plurality of ASPs to be used use a common additional service, user management or charging management for the user 2 can be unified between the plurality of ASPs.

Hence, the user 2 can use a single sign-on environment for the plurality of ASPs and integrate charge payment for the plurality of ASPs.

In addition, an application that is not created with specifications as an ASP application can easily be used by the ASP as an ASP application by receiving an additional service for adding a function necessary for an ASP application. Hence, the ASP can easily rent various kinds of applications and prompt users to use its enriched service.

Even an ASP that cannot provide a sufficient service only by itself can increase the value of the service by using the additional service provided by another ASP.

In addition, an ASP can reduce functions that are managed by itself by requesting the additional services of another ASP so that the management operation can be simplified.

The functions 7 to 10, 13, and 15 of the information processing service providing system according to this embodiment can be realized by causing a computer to load a program recorded on a recording medium 16.

### SECOND EMBODIMENT

In this embodiment, an information processing service providing system which links an ASP service to an additional service will be described in detail.

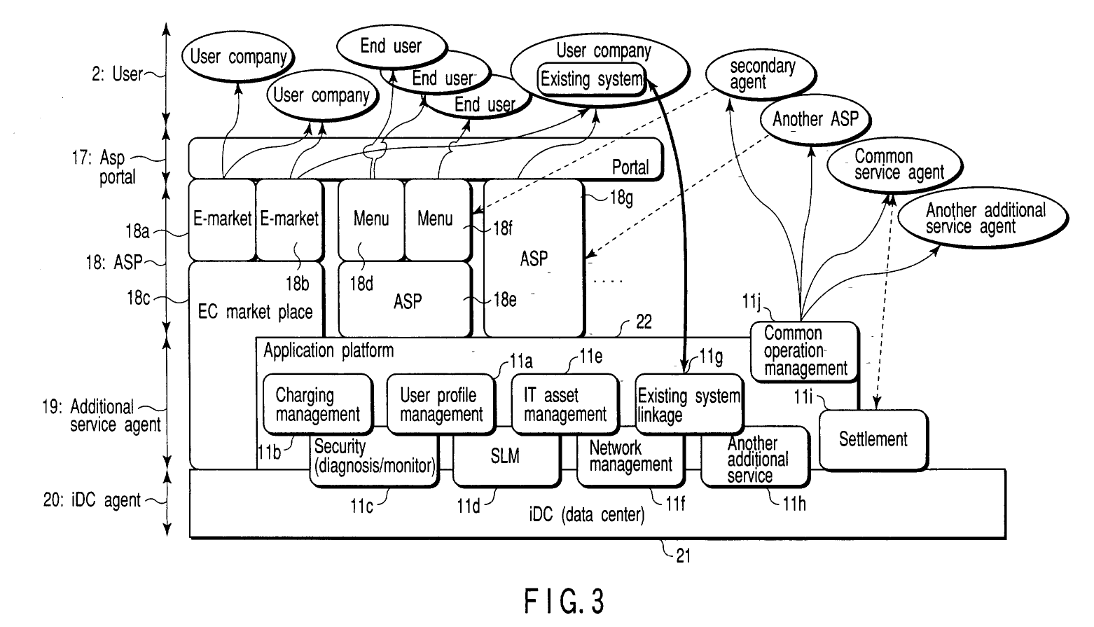

FIG. 3 is a block diagram showing an example of a linkage state of the information processing service providing system according to this embodiment.

The user 2 uses ASP services 18a to 18g by applications of an ASP 18.

An ASP portal 17 executes match making between the user 2 and the ASP 18 and marketing about the ASP 18. The ASP portal 17 also provides linkage between ASPs and an information processing service for it, consultation for users for ASP introduction, and a BPR (Business Process Re-engineering) supporting service.

The ASP 18 provides to the user 2 the ASP services 18a to 18g by ASP applications.

An additional service agent 19 provides additional services 11a to 11j such as an information processing service common to a plurality of ASPs or an ASP operation management service.

The common operation management service 11j as a kind of additional service executes management for the additional service agent 19 to receive the additional service provided by another additional service agent or the ASP service provided by another ASP.

An iDC agent 20 provides a physical infrastructure and operation management service. The iDC agent 20 also executes hosting (server rental) and housing (site rental).

The ASP services 18a to 18g provided by the ASP 18 use the additional services 11a to 11j provided by the additional service agent 19 and an iDC 21 of the iDC agent 20 as needed.

An application platform 22 for providing the additional services 11a to 11j is prepared on the iDC 21.

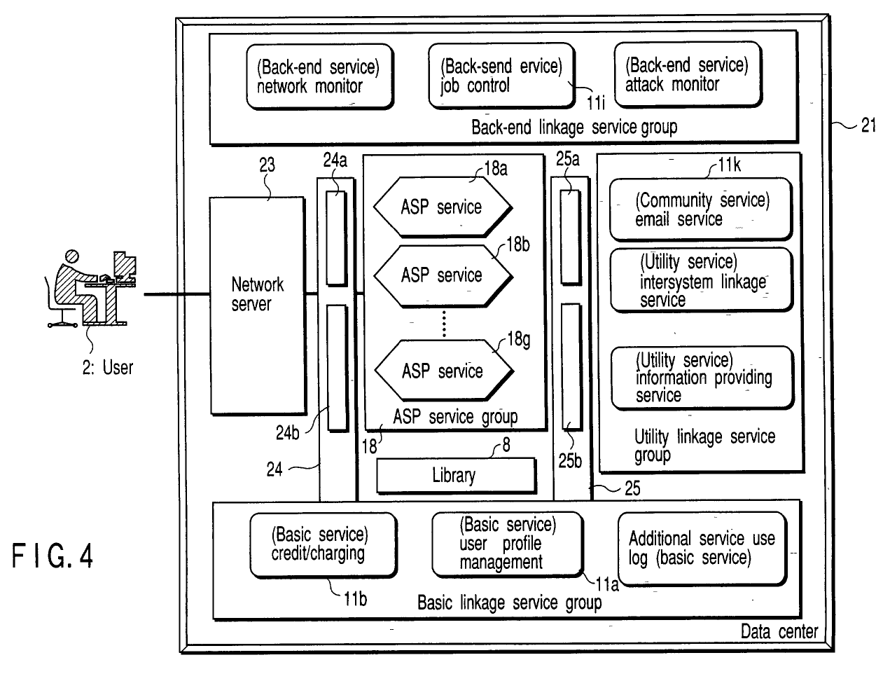

FIG. 4 is a block diagram showing an example of a structure of the information processing service providing system according to this embodiment.

In this embodiment, the additional services 11a to 11j are classified into four types: basic service, communication service, utility service, and back-end service, on the basis of their roles.

The basic service provides a basic function necessary for providing the ASP services 18a to 18g. Examples of the basic service are the user management service 11a, charging management service 11b, security service 11c, and SLM (Service Level Management) service 11d. SLM includes system management with which the ASP guarantees the service quality (the rate of operation and response) for users and service level guarantee using the system management function.

The utility service makes it possible to easily start the ASP services 18a to 18g. The ASP 18 can easily provide a service that is hard for the ASP 18 itself to provide by incorporating the utility service into the service of the ASP 18 as needed. Examples of the utility service are an information analysis service, information providing service, and print service.

The communication service establishes communication between the user 2 and the ASP 18. Examples of the communication service are a portal service and an email service 11k that makes it possible for the user 2 to use email.

The back-end service executes processing at the back end for operation of the ASP services 18a to 18g. Examples of the back-end service are an EDI (Electronic Data Interchange)/EAI (Enterprise Application Integration) service and job control service 11i.

EDI is a mechanism for integrating pieces of information related to commercial transactions into a standard format and electronically exchanging the information between companies. With this mechanism, data related to order/order reception, estimate, settlement, and shipment/reception of goods are converted into digital data in accordance with a predetermined format and transmitted/received through a dedicated line or a network such as a VAN.

EAI includes a technology and software for organically linking a plurality of computer systems used in a company for operations, efficiently integrating data and processes, and supporting the integration.

In this embodiment, on the basis of the linkage methods between the ASP services 18a to 18g and the additional services 11a to 11j, the additional services 11ato 11j are classified into three types: utility linkage service, basic linkage service, and back-end linkage service.

The utility linkage service is invoked from the user 2 or ASP 18 as needed and mainly includes the above utility service and communication service. Invoking the utility linkage service is realized by incorporating a routine for accessing the utility linkage service into the ASP application.

The basic linkage service intervenes when the user 2 accesses the ASP application of the ASP 18. The basic service such as the user management service 11a for authenticating the user 2 and the charging management service 11b for the user 2 by the ASP 18 corresponds to a basic linkage service. The basic linkage service is automatically activated every time a service execution request for the ASP 18 is generated by the client operated by the user 2.

The basic linkage service also includes a service that intervenes when the ASP services 18a to 18g use the additional services 11a to 11j. The basic service such as charging management from the additional service agent 19 to the ASP 18 corresponds to a basic linkage service. The basic linkage service is automatically activated every time the ASP services 18a to 18g invoke the additional services 11a to 11j.

A back-end linkage service monitors and controls the operation state of the ASP 18 itself. The above back-end service correspond to this back-end linkage service. The back-end linkage service executes operation such as activation or stop of processing for the ASP 18 from the additional service agent 19 side.

Three kinds of interfaces that are necessary for realizing linkage between the ASP services 18a to 18g and the utility linkage service, basic linkage service, or back-end linkage service will be described.

Each of the ASP services 18a to 18g and additional services 11a to 11j are executed when a request is output to a corresponding program or hardware or when a corresponding program or hardware is invoked.

Linkage between the utility linkage service and the ASP services 18a to 18g, linkage between the basic linkage service and the ASP services 18a to 18g, and linkage between the back-end linkage service and the ASP services 18a to 18g are realized by the following architecture.

To enable linkage between the utility linkage service and the ASP services 18a to 18g, the information processing service providing system comprises the library 8 which includes the API for invoking the utility linkage service from the ASP services 18a to 18g. At the time of providing the ASP services 18a to 18g, the additional services 11a to 11j are invoked from the side of the ASP services 18a to 18g using the library 8. With this operation, linkage between the utility linkage service and the ASP services 18a to 18g is enabled.

The ASP services 18a to 18g on the invoking side and the utility linkage service on the invoked side sometimes operate on different hardware systems. Hence, in this embodiment as well, the library 8 is preferably usable through a network, as in the first embodiment.

To enable linkage between the basic linkage service and the ASP services 18a to 18g, the information processing service providing system comprises a user-side request acquisition function 24 that requests execution of the basic linkage service in a network server (e.g., a process such as a Web server) 23 which receives a request from the client operated by the user 2.

The processing flow in this case will be described. First, the network server 23 receives a request for the ASP services 18a to 18g from the user 2. A request acquisition function 24a of the user-side request acquisition function 24 acquires the request for the ASP services 18a to 18g from the user 2. A request function 24b requests the function of providing the basic linkage service to execute processing. With this process, control temporarily shifts to the function of providing the basic linkage service. A necessary function such as user authentication is executed. The network server 23 issues a request to the ASP services 18a to 18g. Control shifts to the application for providing the ASP services 18a to 18g.

Additionally, the information processing service providing system comprises an application-side request acquisition function 25 which acquires, with a request acquisition function 25a, a request for a utility linkage service from the application for providing the ASP services 18a to 18g and requests, with a request function 25b, the function of providing the basic linkage service to execute processing.

To realize linkage between the back-end linkage service and the ASP services 18a to 18g, the information processing service providing system steadily monitors the process state of the applications for providing the ASP services 18a to 18g and operates the processes of the applications for realizing the ASP services 18a to 18g from the back-end linkage service in accordance with the process state. If the ASP services 18a to 18g are not independent processes but threads that run on an application server, the monitor function that is executed in the application server is invoked from the back-end linkage service.

The request acquisition function for realizing the architecture for above linkage will be described below in detail.

As described above, the two kinds of request acquisition functions including the user-side request acquisition function 24 and application-side request acquisition function 25 acquire a request and request for providing a service or additional service corresponding to the request.

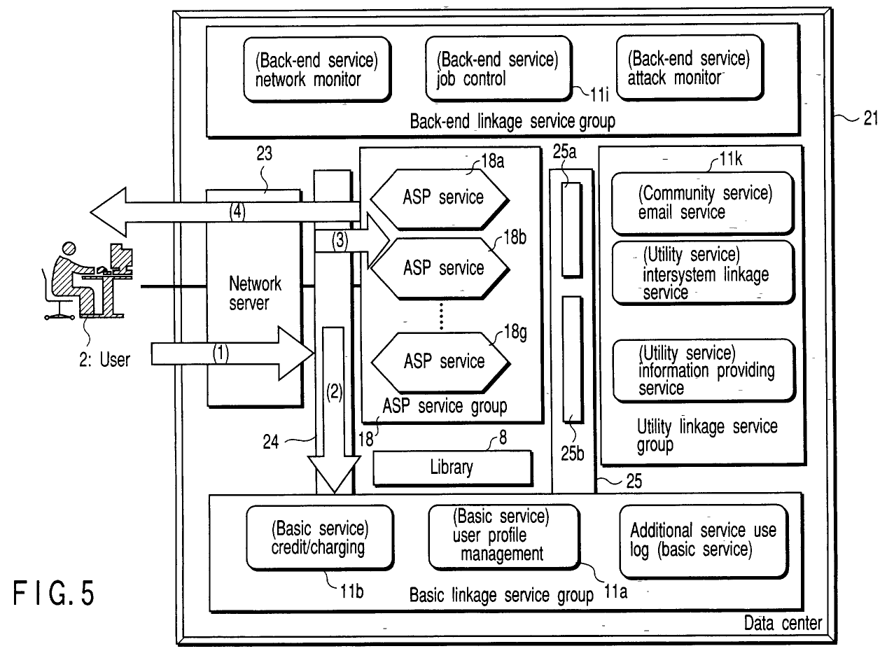

FIG. 5 is a block diagram showing an example of a linkage state by the user-side request acquisition function 24.

The user-side request acquisition function 24 acquires a request for the ASP services 18a to 18g from the user 2 and invokes the basic linkage service. With this invocation, the user 2 who uses the various kinds of ASP services 18a to 18g is identified, and user authentication and charging processing are executed. The application for providing the ASP services 18a to 18g receives the request from the user 2 and returns a result.

That is, the user-side request acquisition function 24 intervenes for use of the ASP services 18a to 18g from the user 2 and requests execution of the user management function such as user authentication and credit/charging.

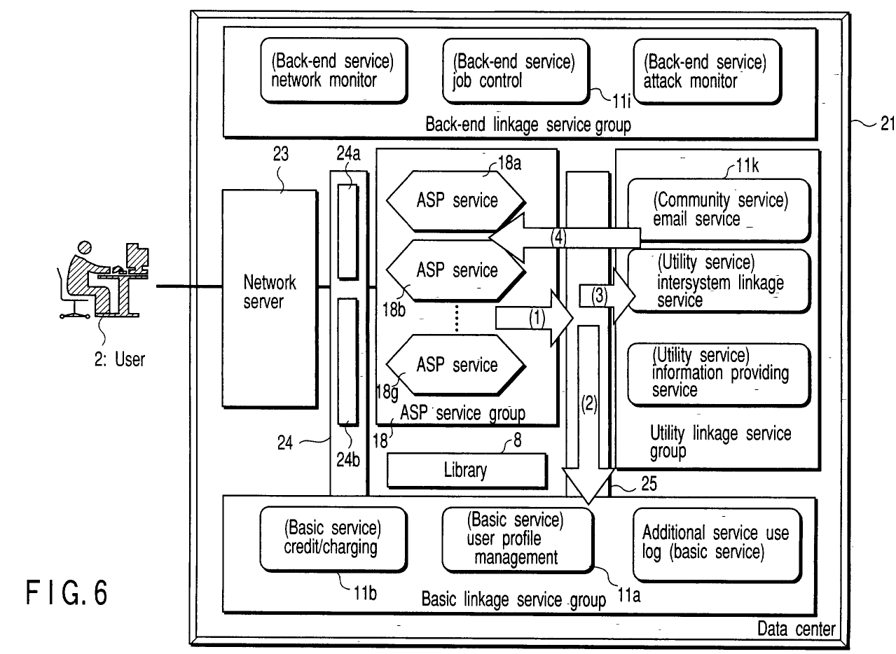

FIG. 6 is a block diagram showing an example of a linkage state by the application-side request acquisition function 25.

The application-side request acquisition function 25 acquires a request for use of the utility linkage service from the application for providing the ASP services 18a to 18g and invokes the basic linkage service. With this invocation, the ASP 18 can be appropriately charged in accordance with the usage of the additional services 11a to 11j by the ASP 18. The function of providing the utility linkage service receives the request from the ASP 18 and returns a result.

That is, the application-side request acquisition function 25 intervenes for use of the additional services 11a to 11j by the ASP 18 and requests execution of management processing such as authentication and credit/charging.

A method of realizing the request acquisition functions 24 and 25 will be described below. A case wherein a request from the user 2 is acquired by the ASP 18 through a Web server will be described below. The request acquisition functions 24 and 25 can be applied to the network server 23 of any type which receives access from the user 2. Examples of additional services to be described below are a service for integrally managing information of users who use at least one ASP that uses the iDC 21, a service for integrally managing charging information of at least one ASP, a service for systematically managing the operation state of at least one ASP, and a service for systematically managing the operation state of at least one service providing function.

The request acquisition function 24 or 25 acquires a request for invoking the function of providing the ASP service or the function of providing the utility linkage service and outputs information related to the request to the function of providing the basic linkage service. With this operation, the additional service is executed. The user 2 uses the ASP application through the Web server.

A basic linkage service 31 includes the user management service 11a and charging management service (credit/charging service) 11b. A utility linkage service 35 includes the email service 11k.

The user management service 11a authenticates the user on the basis of a designated password and also confirms the access right to data requested by the user.

The charging management service 11b investigates the credit state (e.g., whether the fee has reached the upper limit) of a designated user, holds information for charging, and totalizes the fees every month.

The email service 11k sends advertisement mail to a number of addresses and incorporates information (e.g., the name of the user of the designation) specialized to each address in the mail.

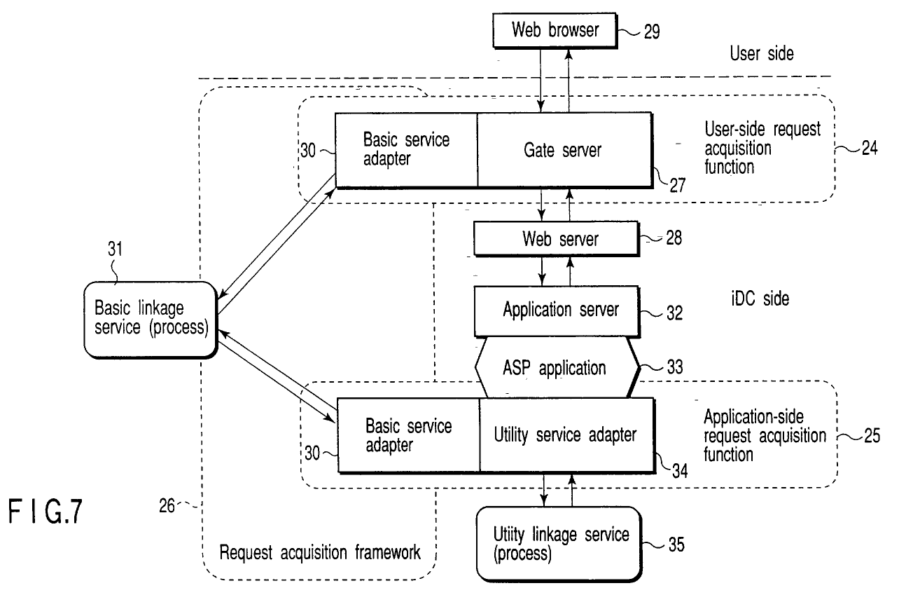

FIG. 7 is a block diagram showing an example of the architecture of the information processing service providing system including the request acquisition functions 24 and 25.

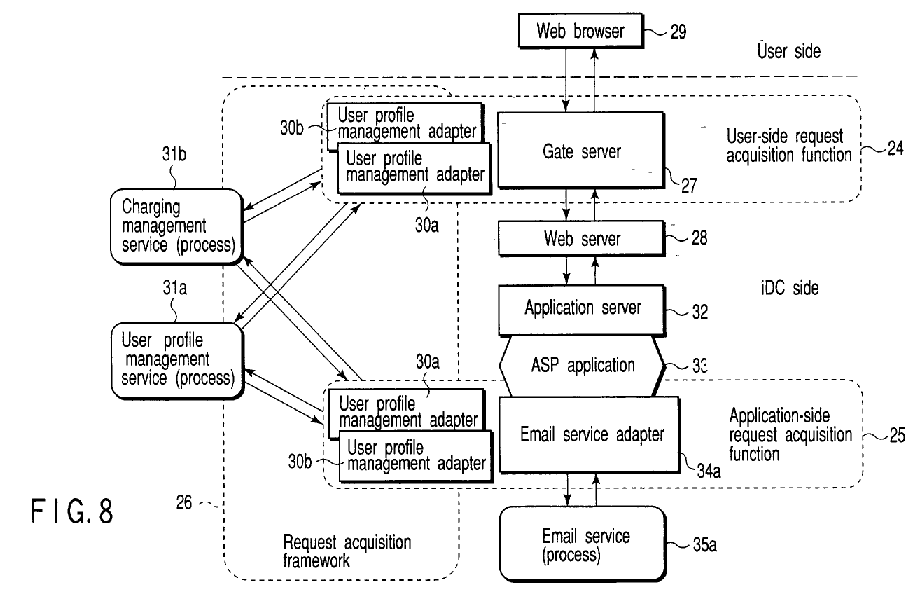

FIG. 8 is a block diagram showing an example of the relationship between concrete services and the architecture of the information processing service providing system.

Since the user-side request acquisition function 24 and application-side request acquisition function 25 comprise many resemble points in terms of function, a common component can be formed. The common component will be assumed a request acquisition framework 26.

The request acquisition framework 26 is developed by, e.g., an object-oriented programming language. A correlation table used by the request acquisition framework 26 is recorded in a file or the like and managed. The correlation between a request and a service is specified by using the correlation table. Hence, the function of the basic linkage service to be activated can be switched in accordance with the type of request.

The user-side request acquisition function 24 is included in a Web server 28 or a Proxy server (to be referred to as a “Gate server” hereinafter) 27 on the input side of the Web server 28. That is, the Gate server 27 realizes the user-side request acquisition function 24.

The user 2 accesses the Web server 28 from a Web browser 29. The user-side request acquisition function 24 of the Gate server 27 acquires a request from the Web browser 29 to the Web server 28. The user-side request acquisition function 24 requests a function (e.g., a process) of providing the basic linkage service 31 (e.g., a user management service 31a or charging management service 31b) to execute processing, using a basic service adapter 30 (e.g., a user management adapter 30a or charging management adapter 30b).

As a result, the user 2 who has accessed the Web server is specified, and his charging information is stored. It is determined whether the user 2 who has accessed the server can use an ASP application 33 on an application server 32.

When the user 2 is permitted to use the ASP application 33, the user 2 uses the ASP application 33. When the user 2 is to use a utility linkage service 35 (e.g., an email service 35a) in addition to the ASP application 33, the application-side request acquisition function 25 acquires a request from the ASP application 33 to a function (e.g., a process) of providing the utility linkage service 35.

The application-side request acquisition function 25 requests the function of providing the basic linkage service 31 to execute processing, using the basic service adapter 30.

As a result, the user 2 who has accessed the Web server is specified, and his charging information is stored. It is determined whether the user 2 who has accessed the server can use the utility linkage service 35.

When use of the utility linkage service 35 is permitted, the ASP application 33 requests the function of providing the utility linkage service 35 to execute processing, using a utility service adapter 34 (e.g., an email service adapter 34a).

With the above linkage, the user management service 11a and charging management service 11b are provided to the ASP18.

As a result, the ASP 18 can provide to the user 2 the email service 11k that is not its original service and add a new value to its service.

When the email service 11k is provided to the ASP 18, the additional service agent 19 can store charging information according to use of the service and bill the ASP 18 for the use.

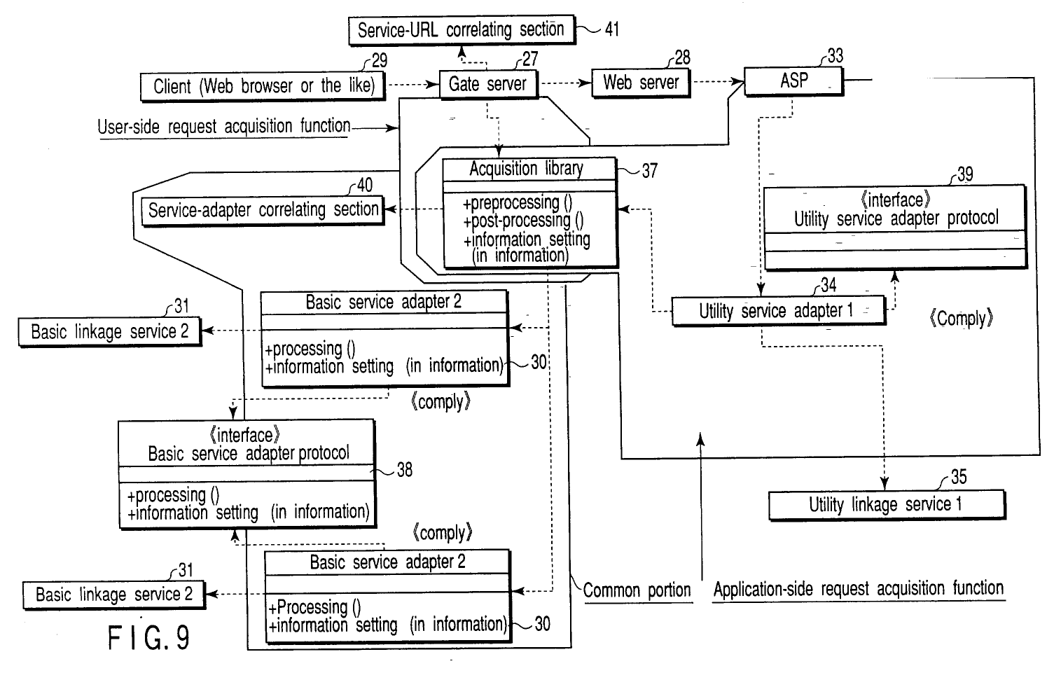

FIG. 9 is a class diagram showing an example of a structure of the request acquisition functions 24 and 25. FIG. 9 is illustrated in the format of a UML (Unified Modeling Language) as one of design description methods.

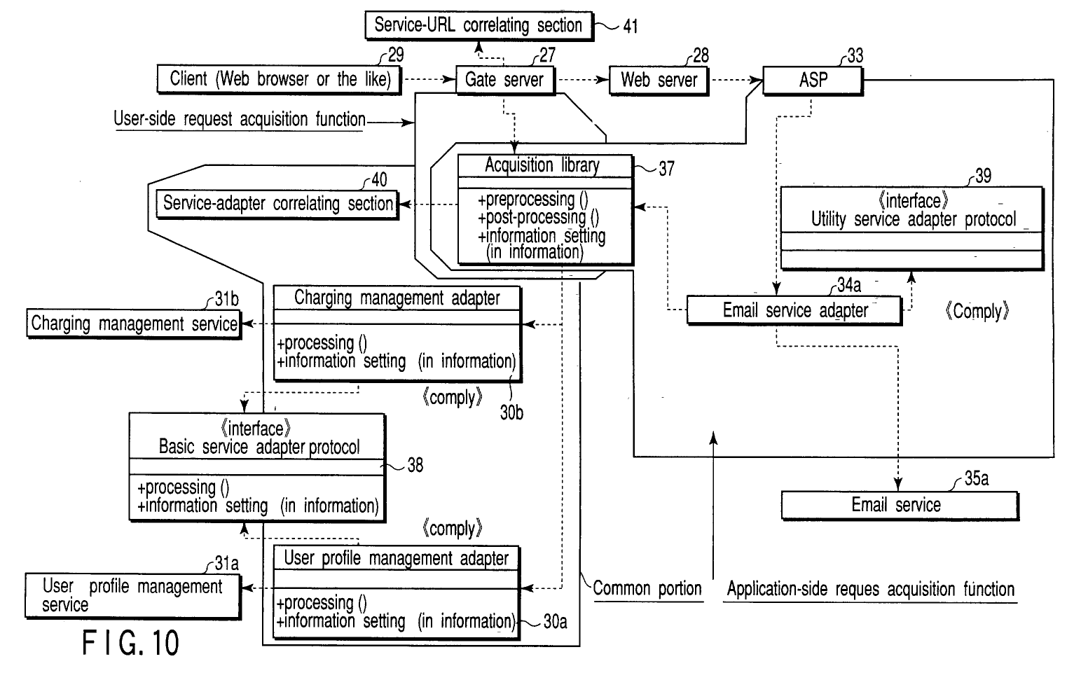

FIG. 10 is a class diagram showing an example of a relationship between concrete services and the structure of the request acquisition functions 24 and 25.

Rectangles and rectangles divided into three parts represent classes. A name (e.g., “Gate server”) described in the rectangles is the name of the class. The rectangle divided into three parts describes the class in more detail. The contents (e.g., “acquisition library”) of the uppermost portion of the rectangles represent a class name. The contents (e.g., “preprocessing ( )” or “post-processing ( )”) of the lowermost portion of the rectangles correspond to methods in object-oriented programming and represent processing requests that can be received by that class.

A broken arrow indicates that the class on the base side accesses the class on the head side to invoke processing or obtain information.

The class 30 (e.g., the user management adapter 30a or charging management adapter 30b) complies with a basic service adapter protocol 38, comprises processing methods, and is invoked by an acquisition library 37.

The class 30 and acquisition library 37 are functions common to the user-side request acquisition function 24 and application-side request acquisition function 25.

The acquisition library 37 is a class serving as the base of the request acquisition functions 24 and 25.

The Gate server 27 invokes the acquisition library 37 and executes the user-side request acquisition function 24.

The utility service adapter 34 (e.g., the email service adapter 34a) complies with a utility service adapter protocol 39 and is used when the utility linkage service 35 (e.g., the email service 35a) is invoked by the ASP application 33.

The utility service adapter 34 invokes the acquisition library 37.

The role of each class of the request acquisition functions 24 and 25 will be described below.

The Gate server 27 serves as a Proxy server that mediates a request from the client 29 to the ASP application 33. The Gate server 27 invokes the acquisition library 37 at least before or after transfer of the request.

The ASP application 33 serves as a function of providing an ASP service. The ASP application 33 uses the utility linkage service 35 (e.g., the email service 35a) during execution of the service.

The acquisition library 37 serves as the base of the request acquisition functions. The acquisition library 37 includes a preprocessing method that is invoked before execution of the function of providing the ASP application 33 or utility linkage service 35, a post-processing method invoked after execution, and an information setting method for receiving information to be transferred to the adapter.

The preprocessing method and post-processing method invoke the basic service adapter 30 in accordance with the contents of a service-adapter correlating section 40. The basic service adapter 30 complies with the basic service adapter protocol 38.

The basic service adapter protocol 38 is a protocol with which an adapter object should comply. The adapter object activates by the acquisition library 37 a function of providing the basic linkage service 31 activated by the request acquisition functions 24 and 25.

More specifically, the basic service adapter protocol 38 defines that a processing method and information setting method are prepared. Any adapter that complies with this protocol can use an arbitrary adapter as the basic service adapter. The iDC agent 20 can change the basic service to be provided to the ASP 18 any time by preparing an adapter complying with the basic service adapter protocol 38.

The basic service adapter 30 (e.g., the credit/charging adapter or user management adapter) is a class complying with a basic service protocol.

The basic linkage service 31 (e.g., the user management service 31a or charging management service 31b) executes user authentication, charging, or recording of an execution state log.

The utility service adapter 34 used from the ASP application 33 should comply with the utility service adapter protocol 39.

The utility service adapter 34 (e.g., the email service adapter 34a) is a class for transferring a request from the ASP application 33 to the function of providing the utility linkage service 35. This class invokes the preprocessing method and post-processing method of the acquisition library 37 before and after transfer.

The utility linkage service 35 (e.g., the email service 35a) is used from the ASP application 33.

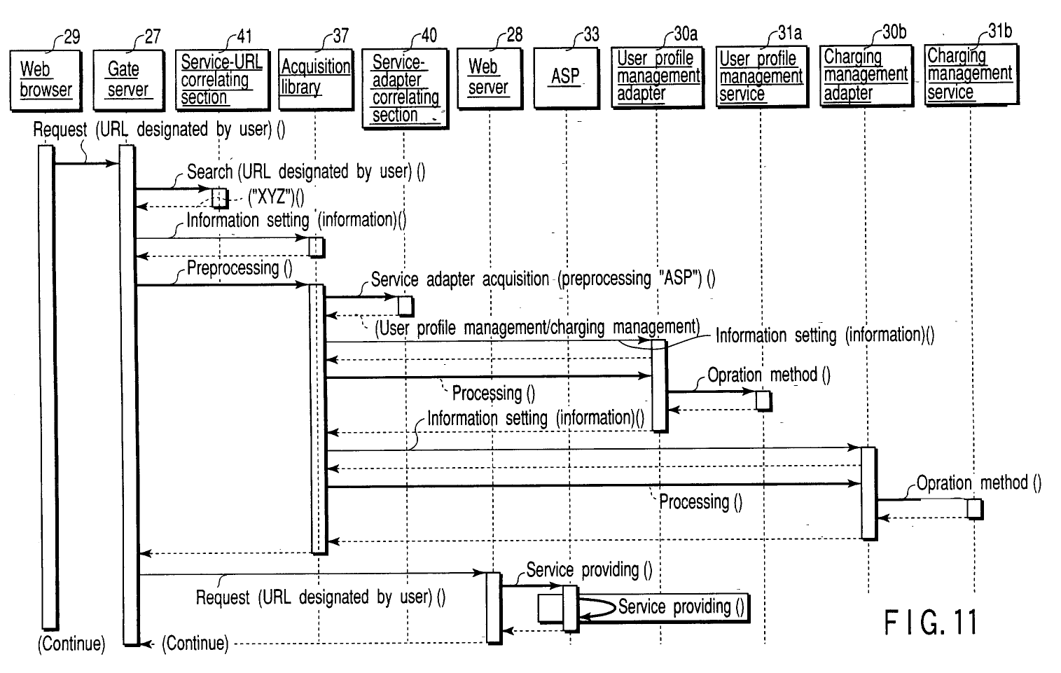

FIG. 11 is a sequence chart showing an example of the first-half operation of the user-side request acquisition function 24. FIG. 11 shows processing before the user uses the ASP application 33.

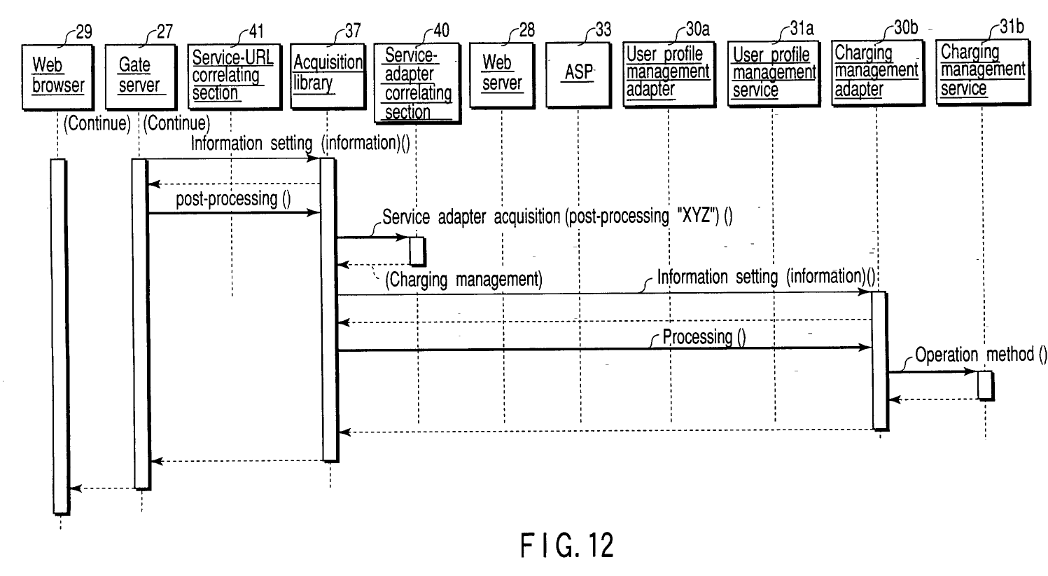

FIG. 12 is a sequence chart showing an example of the second-half operation of the user-side request acquisition function 24. FIG. 12 shows processing after the user 2 has used the ASP application 33.

Before the ASP application 33 is used by the Web browser 29 of the user 2, the function of providing the user management service 31a checks authenticity of the user 2. The function of providing the charging management service 31b checks the ASP use charge of the user 2.

After the user 2 has used the ASP application 33, the function of providing the charging management service stores charging information of the user 2.

A solid arrow in the sequence charts indicates method invocation. A broken arrow indicates that invoked processing is ended, and control returns. Either arrow has the name of a method (for a solid arrow, an argument is described in ( )) to be invoked as needed and a value to be returned. The value to be returned is described in ( ). Invocation of a method that has an important function in realizing the acquisition library 37 is emphasized by a bold line.

As shown in FIG. 11, the user 2 requests use of the ASP application 33 using a client such as the Web browser 29. At this time, the user 2 has not accessed the Web server 28 yet. Actually, the Gate server 27 receives the request.

The Gate server 27 executes search processing to grasp the requested service on the basis of a URL designated by the user 2. A service-URL correlating section 41 is requested to execute this search processing.

Table 1 shows an example of a correlation table used by the service-URL correlating section 41.

TABLE 1

| Service name | URL |
|---|---|
| ASP top | /ASP/ASP.jsp |
| Charging information | /ASP/accounting.jsp |
| browsing | |
| Supplement | /ASP/option.jsp |
| System linkage 1 | /ASP/trans.jsp |
| System linkage 2 | /servlet/asp.transSvr |
| XYZ | /XYZ/xyz.jsp |

When Table 1 is referred, a service such as “XYZ” can be obtained from the URL.

The Gate server 27 transfers information such as the thus obtained service name and the user name input by the user 2 to the acquisition library 37. The pieces of information such as the service name and user name are transferred from the acquisition library 37 to the respective adapters later and used as arguments by the function of providing the basic linkage service to execute processing.

Table 2 shows an example of values transferred from the user-side request acquisition function 24 to the function of providing the basic linkage service as arguments.

TABLE 2

| Item name | Value |
|---|---|
| User name | “ABCD” |
| Password | “1111111111” |
| Service name of | “XYZ” |
| invoking source | |
| Service name of | “Gate_server” |
| invoking destination | |
| Data size | — |
| Data type | — |
| End state | — |

Table 3 shows an example of values transferred from the application-side request acquisition function 25 to the function of providing the basic linkage service as arguments.

TABLE 3

| Item name | Value |
|---|---|
| User name | “ASP33_Manager” |
| Password | “aaaaaa” |
| Service name of | “Email.mail_{—} |
| invoking source | transmission” |
| Service name of | “XYZ” |
| invoking destination | |
| Data size | — |
| Data type | — |
| End state | — |

The Gate server 27 executes the preprocessing method of the acquisition library 37. Then, the acquisition library 37 requests the service-adapter correlating section 40 to acquire adapters and acquires adapters necessary for preprocessing of the ASP application 33.

Table 4 shows an example of a table used by the service-adapter correlating section 40.

TABLE 4

| Service | Adapter | |
|---|---|---|
| XYZ.preprocessing | User profile management, | For user-side |
| | charging management | request |
| XYZ.post-processing | Charging management | acquisition |
| System_linkage1. | User profile management | unction |
| preprocessing | | |
| System_linkage2.post- | Charging management, | |
| processing | additional service use log | |
| . . . | . . . | |
| Email.mail_transmission. | User profile management, | For applica- |
| preprocessing | charging management | tion-side |
| Email.mail_transmission. | Charging management | request |
| post-processing | | acquisiton |
| Email.mail_reception. | User profile management | function |
| preprocessing | Charging management, | |
| Email.mail_reception. | Charging management, | |
| post-processing | additional service use log | |
| . . . | . . . | |

More specifically, since the acquisition library 37 has already received information shown in Table 2, search for Table 4 is executed using “XYZ” as a keyword.

The acquisition library 37 selects the user management adapter 30a and charging management adapter 30b as adapters necessary for preprocessing of the ASP application 33.

The acquisition library 37 invokes a function of providing an actual service using the selected adapter. First, the acquisition library 37 invokes the function of providing the user management service 31a. Then, the acquisition library 37 invokes the function of providing the charging management service 31b. More specifically, the acquisition library 37 transfers the pieces of information in Table 2, which are set by the preceding processing, to the selected adapters. Each adapter invokes a processing method prepared in itself.

The user management adapter 30a invokes an operation method specialized to the function of providing the user management service 31a and also transfers the user name and password to the function of providing the user management service 31a.

The user management adapter 30a receives from the function of providing the user management service 31a a result obtained by checking whether the user is an authentic user. The result is also returned from the user management adapter 30a to the acquisition library 37.

If the check result has no problem, the charging management adapter 30b invokes the method of the charging management service 31b. The charging management service 31b executes credit management to check whether, e.g., the usage charge of the user exceeds the upper limit value of the agreement.

When this processing is ended, control returns from the acquisition library 37 to the Gate server 27.

The Gate server 27 notifies the Web server 28 of the URL designated by the user 2. A service by the ASP application 33 is provided. Examples of the service are providing the function of an ordering system and providing the function of a schedule management tool.

Subsequently, as shown in FIG. 12, the Gate server 27 transfers to the acquisition library 37, using the information setting method, pieces of information that are transferred to the function of providing the basic linkage service and used in post-processing. The pieces of information transferred include, e.g., the user's connection time which is used for charging and time information used to record a log.

The Gate server 27 invokes the post-processing method of the acquisition library 37. As in preprocessing, the acquisition library 37 acquires necessary adapters from the service-adapter correlating section 40 and invokes processing methods of corresponding adapters. With this processing, the basic linkage service (in this example, the charging management service 31b) is provided.

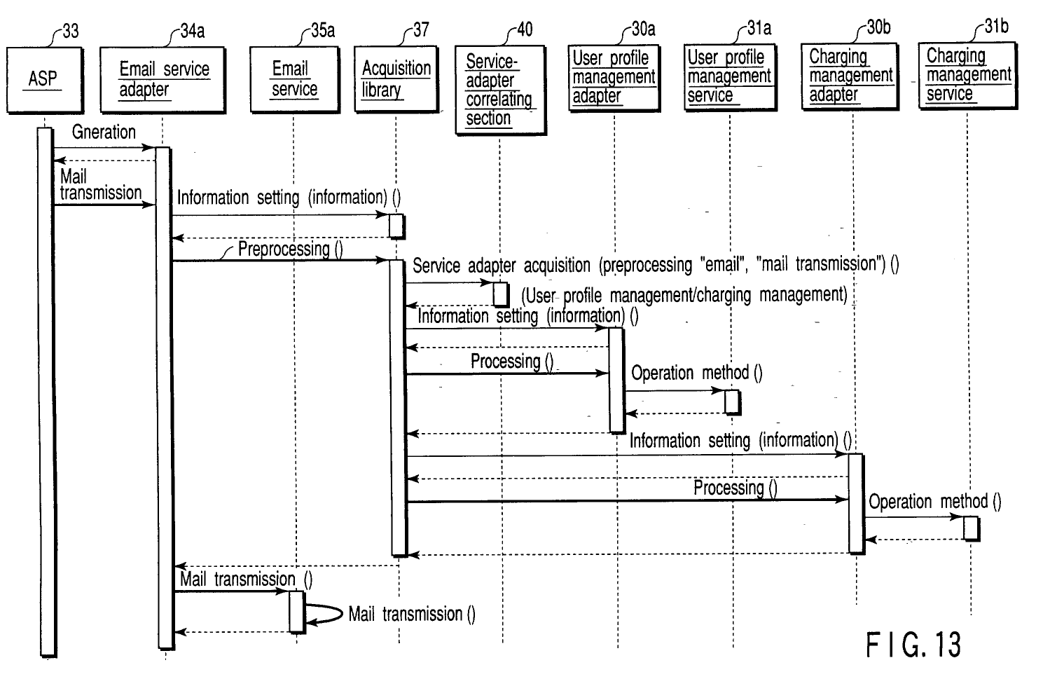

FIG. 13 is a sequence chart showing an example of the first-half operation of the application-side request acquisition function 25. FIG. 13 shows processing until the user 2 uses the email service 35a. In this way, the type of additional service to be provided can be switched by using the service-adapter correlating section 40. When the additional services are set by a table like Table 4, the type of additional service to be provided to the ASP can be changed only by updating the table. Hence, the iDC agent 20 can easily do management and operation and flexibly provide any type of additional service to the ASP.

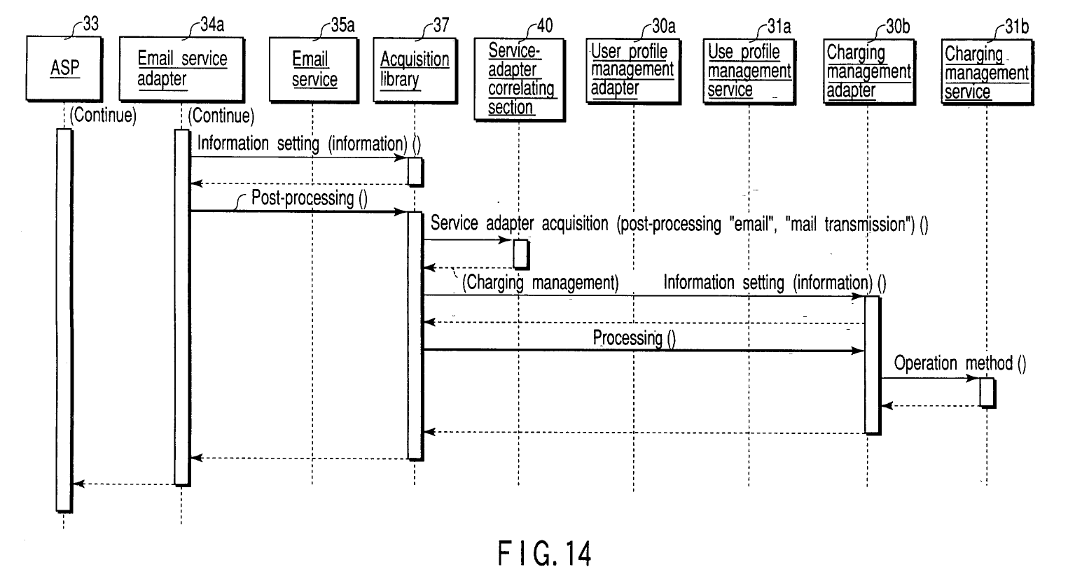

FIG. 14 is a sequence chart showing an example of the second-half operation of the application-side request acquisition function 25. FIG. 14 shows processing after the user 2 has used the email service 35a.

FIGS. 13 and 14 are described from when the ASP application 33 is already used. FIGS. 13 and 14 exemplify a case wherein the email service 35a is used in compliance with a mail transmission request from the user 2.

Before the email service 35a as one of the utility linkage services is used by part of processing of the ASP application 33, authentication check of the ASP 18 as the requesting side of the user management service 31a is executed, and the charging management service 31b checks the additional service usage charge of the ASP 18 on the processing requesting side.

After the email service 35a as one of the utility linkage services is used by part of processing of the ASP application 33, the charging management service 31b stores charging information of the ASP 18 on the requesting side.

First, as shown in FIG. 13, the ASP application 33 generates the email service adapter 34a and requests the adapter 34a to transmit mail.

The email service adapter 34a transfers information to the acquisition library 37.

The acquisition library 37 invokes the preprocessing method, requests the function of providing the actual email service 35a to execute mail transmission processing, and invokes the post-processing method, as shown in FIG. 14.

The acquisition library 37 uses the service name “email” and the method name “mail transmission” as a keyword used to acquire an adapter. The remaining operations of the acquisition library 37 are the same as in the user-side request acquisition function 24. Like the user-side request acquisition function 24, the service-adapter correlation table as in Table 4 is used. The type of additional service to be provided to the ASP 18 is not fixed, and the flexibility can be increased. For this reason, the iDC agent 20 can provide an additional service that meets the requirement of the ASP 18. In addition, even when the contents of the agreement with the ASP 18 have changed, the table can be continuously used only by updating it. Since the library itself need not be re-compiled, the operation cost on the iDC agent 20 side can be reduced.

When each adapter is initialized at the necessary time, a processing time is required from an adapter selection request to providing a service. Hence, the processing speed may be increased by generating adapters and pooling (reserving) them in advance.

When the above information processing service providing system is implemented, the iDC agent 20 and ASP 18 can obtain the following advantages.

When the application platform 22 is prepared on the iDC 21, the iDC agent 20 can provide various kinds of additional services that cannot be realized only by simply using the iDC 21. Hence, the iDC agent 20 can easily provide appropriate functions to ASPs which require use of different functions. In addition, the iDC agent 20 can obtain a value from the user 2 or ASP 18 that has used the additional service in accordance with use of it.

When the contents of the agreement with the ASP 18 have changed, the iDC agent 20 can easily reflect the changed contents on the business and easily add/change the type of function of realizing a service to be provided and the contents of the service. Hence, the iDC agent 20 can reduce the operation/maintenance cost of the business and increase the use efficiency.

The iDC agent 20 provides an additional service provided by another ASP to the ASP 18. With this operation, the iDC agent 20 can increase the added value of its data center as compared to business with an independent data center. Hence, the number of users 2 and ASPs that use its data center can be increased.

The ASP 18 can link an additional service with the ASP service provided by itself.

The ASP 18 also provides a service to the user 2 in linkage with another ASP. With this operation, the number of functions usable by the user 2 can be increased, and convenience for the user 2 can be increased. In addition, the number of opportunities of use by the user 2 can be increased.

Even when the ASP 18 has no technology necessary for providing an additional service, it can easily enrich the services by using an additional service provided by another ASP.

In addition, when an application that does not aim at providing an ASP service is to be functioned as an application for an ASP service, the ASP 18 can supplement functions (e.g., charging management and system monitor functions) necessary for an ASP by an additional service. Hence, any software can easily be used as an ASP.

The ASP 18 can share user management and charging monument with another ASP. For this reason, a single sign-on environment for a plurality of ASPs can be provided to the user 2, and bills can be integrated. The single sign-on environment for a plurality of ASPs or bill integration also facilitates management for the user 2. Hence, user acquisition can be promoted.

### THIRD EMBODIMENT

The arrangement of the functions and elements in the information processing service providing system according to each of the above embodiments may be changed if the same functions and operations can be realized. The functions and elements may be freely combined or divided.

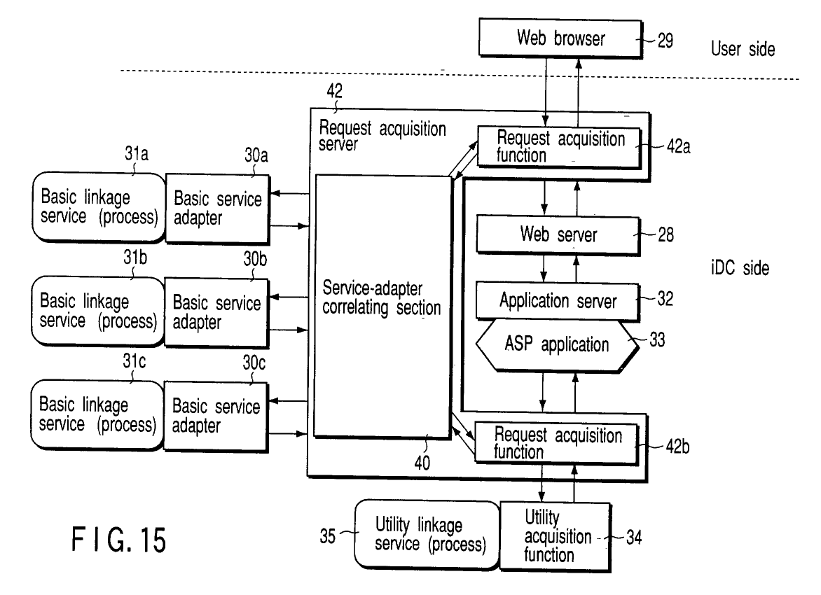

FIG. 15 is a block diagram showing an example of an information processing service providing system according to this embodiment. FIG. 15 shows a modification of the information processing service providing system shown in FIG. 7.

Functions of providing basic linkage services 31a to 31c receive or issue a request through basic linkage adapters 31a to 31c.

A function of providing a utility linkage service 35 receives or issues a request through a utility service adapter 34.

A request acquisition server 42 comprises request acquisition functions 42a and 42b and service-adapter correlating section 40.

The request acquisition server 42 acquires a request from each of a Web browser 29, the function of providing the additional services 31a to 31c and 35, and the ASP application 33, selects the ASP application 33 or the function of providing the additional services 31a to 31c or 35 in accordance with the acquired request in accordance with the contents of the service-adapter correlating section 40, and sends the request to the selected ASP application 33 or the function of providing the additional services 31a to 31c or 35.

With this modification, any information processing service can use another information processing service, and linkage between the services can be efficiently realized. As a result, a function that combines an ASP application and a plurality of additional functions can easily be constructed or customized.

For example, a function of providing an additional service can request a function of providing another additional service to execute processing. The plurality of functions of providing services can be freely linked to provide one information processing service.

The functions and elements of the information processing service providing system according to each of the above embodiments are realized as a program, module, or process that can be executed by a computer. When the functions and elements are to be provided by the program, it can be written on a recording medium 16 such as a magnetic disk (e.g., a flexible disk or hard disk), optical disk (e.g., a CD-ROM or DVD), or a semiconductor memory and applied to the computer. The program may be transmitted to the computer or computer system by a communication medium. The computer loads the program. The program controls the operation of the computer, and the above-described processing is executed.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. A method for providing information processing service by a computer, comprising:
detecting an event which requests an additional information processing service associated with an information processing service provided through a network;
when the event is detected, referring to a library in which invocation of an additional function of providing the additional information processing service is defined; and
on the basis of a reference result of the library, requesting the additional function of providing the additional information processing service to execute processing.

2. The method for providing information processing service according to claim 1, further comprising
detecting a linkage event with which another additional information processing service is requested from the additional information processing service,
when the linkage event is detected, referring to the library in which invocation of an additional function of providing the another additional information processing service is defined, and
on the basis of a reference result of the library, requesting the additional function of providing the another additional information processing service to execute processing.

3. The method for providing information processing service according to claim 1, wherein the additional function is commonly used by a plurality of information processing services.

4. A method for providing information processing service by a computer, comprising:
recording data that represents an operation state of an information processing service provided through a network; and
providing the recorded data that represents the operation state to an additional function of providing an additional information processing service associated with the information processing service.

5. The method for providing information processing service according to claim 4, further comprising
recording data that represents an operation state of the additional information processing service, and
providing the recorded data that represents the operation state of the additional information processing service to an additional function of providing another additional information processing service associated with the additional information processing service.

6. The method for providing information processing service according to claim 4, wherein the additional function is commonly used by a plurality of information processing services.

7. A method for providing information processing service by a computer, comprising:
acquiring a request of an information processing service provided through a network; and
in compliance with the request, requesting an additional function to execute processing, wherein the additional function provides an additional information processing service associated with the information processing service.

8. The method for providing information processing service according to claim 7, further comprising
acquiring a request of the additional information processing service, and
in compliance with the request of the additional information processing service, requesting an additional function of providing another additional information processing service associated with the additional information processing service to execute processing.

9. The method for providing information processing service according to claim 7, further comprising, between acquisition of the request and the request of execution, referring to a table that correlates the request with the additional function, thereby specifying the additional function corresponding to the request.

10. The method for providing information processing service according to claim 7, wherein the additional function is commonly used by a plurality of information processing services.

11. A method for providing information processing service by a computer, comprising:
acquiring a request of an additional information processing service, which is generated on the basis of processing of an information processing service provided through a network; and
in compliance with the request, requesting an additional function to execute processing, wherein the additional function provides the additional information processing service.

12. The method for providing information processing service according to claim 11, further comprising
acquiring a request of another additional information processing service, which is generated on the basis of processing of the additional information processing service, and
in compliance with the request of the another additional information processing service, requesting an additional function of providing the another additional information processing service to execute processing.

13. The method for providing information processing service according to claim 11, the method is further comprising, between acquisition of the request and the request of execution, referring to a table that correlates the request with the additional function, thereby specifying the additional function corresponding to the request.

14. The method for providing information processing service according to claim 11, wherein the additional function is commonly used by a plurality of information processing services.

15. An article of manufacture comprising a computer usable medium having computer readable program code means embodied therein, the computer program code means comprising:
a detection computer readable program code that detects an event which requests an additional information processing service associated with an information processing service provided through a network;
a reference computer readable program code that, when the event is detected, refers to a library in which invocation of an additional function of providing the additional information processing service is defined; and
a request computer readable program code that, on the basis of a reference result of the library, requests the additional function of providing the additional information processing service to execute processing.

16. The article of manufacture comprising a computer usable medium according to claim 15, wherein
the detection computer readable program code is a code that detects a linkage event with which another additional information processing service is requested from the additional information processing service,
the reference computer readable program code is a code that, when the linkage event is detected, refers to the library in which invocation of an additional function of providing the another additional information processing service is defined, and
the request computer readable program code is a code that, on the basis of a reference result of the library, requests the additional function of providing the another additional information processing service to execute processing.

17. An article of manufacture comprising a computer usable medium having computer readable program code means embodied therein, the computer program code means comprising:
a record computer readable program code that records data that represents an operation state of an information processing service provided through a network; and
a request computer readable program code that provides the recorded data that represents the operation state to an additional function of providing an additional information processing service associated with the information processing service.

18. The article of manufacture comprising a computer usable medium according to claim 17, wherein
the record computer readable program code is a code that records data that represents an operation state of the additional information processing service, and
the request computer readable program code is a code that provides the recorded data that represents the operation state of the additional information processing service to an additional function of providing another additional information processing service associated with the additional information processing service.

19. An article of manufacture comprising a computer usable medium having computer readable program code means embodied therein, the computer program code means comprising:
an acquisition computer readable program code that acquires a request of an information processing service provided through a network; and
a request computer readable program code that, in compliance with the request, requests an additional function to execute processing, wherein the additional function provides an additional information processing service associated with the information processing service.

20. The article of manufacture comprising a computer usable medium according to claim 19, wherein
the acquisition computer readable program code is a code that acquires a request of the additional information processing service, and
the request computer readable program code is a code that, in compliance with the request of the additional information processing service, requests an additional function of providing another additional information processing service associated with the additional information processing service to execute processing.

21. The article of manufacture comprising a computer usable medium according to claim 19, wherein
the request computer readable program code is a code that, to request the additional function of providing the additional information processing service to execute processing, refers to a table that correlates the request with the additional function, thereby specifies the additional function corresponding to the request.

22. An article of manufacture comprising a computer usable medium having computer readable program code means embodied therein, the computer program code means comprising:
an acquisition computer readable program code that acquires a request of an additional information processing service, which is generated on the basis of processing of an information processing service provided through a network; and
a request computer readable program code that, in compliance with the request, requests an additional function to execute processing, wherein the additional function provides the additional information processing service.

23. The article of manufacture comprising a computer usable medium according to claim 22, wherein
the acquisition computer readable program code is a code that acquires a request of another additional information processing service, which is generated on the basis of processing of the additional information processing service, and
the request computer readable program code is a code that, in compliance with the request of the another additional information processing service, requests an additional function of providing the another additional information processing service to execute processing.

24. The article of manufacture comprising a computer usable medium according to claim 22, wherein
the-request computer readable program code is a code that, to request the additional function of providing the additional information processing service to execute processing, refers to a table that correlates the request with the additional function, thereby specifies the additional function corresponding to the request.

25. A system for providing information processing service, comprising:
a detection unit that detects an event which requests an additional information processing service associated with an information processing service provided through a network;
a reference unit that, when the event is detected, refers to a library in which invocation of an additional function of providing the additional information processing service is defined; and
a request unit that, on the basis of a reference result of the library, requests the additional function of providing the additional information processing service to execute processing.

26. A system for providing information processing service, comprising:
a record unit that records data that represents an operation state of an information processing service provided through a network; and
a request unit that provides the recorded data that represents the operation state to an additional function of providing an additional information processing service associated with the information processing service.

27. A system for providing information processing service, comprising:
an acquisition unit that acquires a request of an information processing service provided through a network; and
a request unit that, in compliance with the request, requests an additional function to execute processing, wherein the additional function provides an additional information processing service associated with the information processing service.

28. A system for providing an information processing service, comprising:
an acquisition unit that acquires a request of an additional information processing service, which is generated on the basis of processing of an information processing service provided through a network; and
a request unit that, in compliance with the request, requests an additional function to execute processing, wherein the additional function provides the additional information processing service.
